(19) United States
(12) Patent Application Publication
(10) Pub. No.: US 2023/0206188 A1
(43) Pub. Date: Jun. 29, 2023

(54) USING MULTIPLE DATA SOURCES FOR COMMUNICATION EVENT ACTION IDENTIFICATION

(71) Applicant: salesforce.com, inc., San Francisco, CA (US)

(72) Inventors: Muhammad Shahid Khan, Calgary (CA); Steighton Lee Haley, Oakland, CA (US); Anuradha Sunil Vakil, Fremont, CA (US); Noah William Burbank, Palo Alto, CA (US); Rohit Deshpande, Fremont, CA (US); Alexander Oscherov, Danville, CA (US); Ajay Ajit Shah, Portola Valley, CA (US); David Tomas Fernandez, Mattituck, NY (US); Megan Monacelli, San Francisco, CA (US)

(21) Appl. No.: 17/646,110

(22) Filed: Dec. 27, 2021

(51) Int. Cl. G06Q 10/10; G06F 40/205; G06N 20/00

(52) U.S. Cl. CPC G06Q 10/1095; G06Q 10/107; G06F 40/205; G06N 20/00

(57) ABSTRACT

An application server may identify one or more contact identifiers associated with one or more contacts associated with a communication event. The application server may retrieve information associated with the one or more contacts from one or more data sources based on the one or more contact identifiers. The application server may generate, based on the information retrieved from the one or more data sources, a set of contact characteristics for the one or more contacts. The application server may identify one or more actions to be performed via the electronic communication application and associated with the communication event based at least in part on the generated set of contact characteristics and a response status. The application server may transmit, to a user device, an indication of the identified one or more actions.

### FIELD OF TECHNOLOGY

The present disclosure relates generally to database systems and data processing, and more specifically to using multiple data sources for communication event action identification.

### BACKGROUND

A cloud platform (i.e., a computing platform for cloud computing) may be employed by many users to store, manage, and process data using a shared network of remote servers. Users may develop applications on the cloud platform to handle the storage, management, and processing of data. In some cases, the cloud platform may utilize a multi-tenant database system. Users may access the cloud platform using various user devices (e.g., desktop computers, laptops, smartphones, tablets, or other computing systems, etc.).

In one example, the cloud platform may support customer relationship management (CRM) solutions. This may include support for sales, service, marketing, community, analytics, applications, and the Internet of Things. A user may utilize the cloud platform to help manage contacts of the user. For example, managing contacts of the user may include analyzing data, storing and preparing communications, and tracking opportunities and sales.

A cloud platform may support a communication application, such as an email application, meeting application, messaging application, or a combination thereof. In some cases, the communication application can be used to coordinate communication events and invite participants. However, these applications may not have access to various data resources or may not have the functionality to improve communication insights.

### BRIEF DESCRIPTION OF THE DRAWINGS

FIG. 1 illustrates an example of data processing at an application server system that supports using multiple data sources for communication event action identification in accordance with aspects of the present disclosure.

FIG. 2 illustrates an example of a data processing system that supports using multiple data sources for communication event action identification in accordance with aspects of the present disclosure.

FIG. 3 illustrates an example of a data processing system that supports using multiple data sources for communication event action identification in accordance with aspects of the present disclosure.

FIG. 4 illustrates an example of a process flow that supports using multiple data sources for communication event action identification in accordance with aspects of the present disclosure.

FIG. 5 shows a block diagram of an apparatus that supports using multiple data sources for communication event action identification in accordance with aspects of the present disclosure.

FIG. 6 shows a block diagram of a communication event manager that supports using multiple data sources for communication event action identification in accordance with aspects of the present disclosure.

FIG. 7 shows a diagram of a system including a device that supports using multiple data sources for communication event action identification in accordance with aspects of the present disclosure.

FIGS. 8 through 11 show flowcharts illustrating methods that support using multiple data sources for communication event action identification in accordance with aspects of the present disclosure.

### DETAILED DESCRIPTION

Coordination and scheduling of business meetings often involves the use of meeting tools (e.g., hosted or accessed through a cloud computing system) to invite people to meetings and to monitor which invitees have responded regarding their attendance, suggest changes to the meeting (e.g., time, date, or other aspects of the meeting), and generally coordinate details about the meeting (e.g., attachments, agendas, or other aspects). In the course of business, a cloud computing service may obtain or store information about various companies, employees, or contacts, such as job roles (e.g., company officers, attorney, social media manager, travelling salesperson, network manager), job functions (e.g., executive, legal, marketing, sales, IT), job levels (e.g., individual, senior individual, manager, senior manager, executive), or other information. Such information may be stored across various different systems, databases, or locations. However, such systems are often isolated and retrieval or collection of such information across various disparate sources is difficult. As such, information from such sources is not available to users of meeting tools, and it is difficult for users to make judgments about scheduling, rescheduling, modifying, or otherwise managing meetings.

The subject matter disclosed herein involves the collection and analysis of such data from the varied data sources and further involves the identification, selection, or suggestion of an action (e.g., send a follow-up invitation or reminder, suggest additional invitees) or other results obtained from the data collection and analysis. For example, if a meeting organizer is coordinating a meeting using meeting tools via a cloud computing cloud platform, the cloud platform may determine an identity of each invitee and may collect information associated with the invitees (e.g., RSVP status, job title, job function, job level, or other information). For example, the cloud platform may determine that one invitee is a high-level executive that has not yet responded to the meeting invite. Such an invitee may be important to have in the meeting, and without their presence, the meeting may not be productive. As such, the cloud platform may, in the case of the high-level executive that has not yet responded, suggest that a follow-up message or invitation be sent to the high-level executive, or the cloud platform may suggest that the meeting should be rescheduled. In another example, if the cloud platform determines that a lawyer from another organization may be attending the meeting, the cloud platform may suggest to the user that an invitation should be sent to a lawyer from the user's organization. In this way, a user may obtain “insights” or characteristics about a proposed meeting using information from scattered data sources that are not normally available to existing meeting tools. Further, various different sources of information and cloud platforms commonly used in isolation may be brought together for collaborative use, improving the functioning of the cloud platforms individually and collectively.

In some examples, the cloud platform may utilize job levels, job roles, response statuses, or other characteristics or attributes of invitees to perform the functions or approaches described herein. In some examples, the cloud platform may receive (e.g., from a user) a selection of one or more actions that were previously suggested by the cloud platform, and may transmit one or more messages based on the selection (e.g., implementing the actions that were selected). In some examples, the cloud platform may identify aspects of a meeting event to provide further “insights” about the meeting event. For example, the cloud platform may suggest or provide information about a proposed location for the meeting (e.g., a conference room may have an associated capacity, but the number of invitees may change, and a different meeting location may be desirable). In this way, management of communication events may be more efficient and may integrate the use of various systems that previously may have been used in isolation.

Aspects of the disclosure are initially described in the context of an environment supporting an on-demand database service. Aspects of the disclosure are then described with reference to example system diagrams that support data collection and analysis for communication event action identification and a process flow illustrating operations to support communication event action identification. Aspects of the disclosure are further illustrated by and described with reference to apparatus diagrams, system diagrams, and flowcharts that relate to using multiple data sources for communication event action identification.

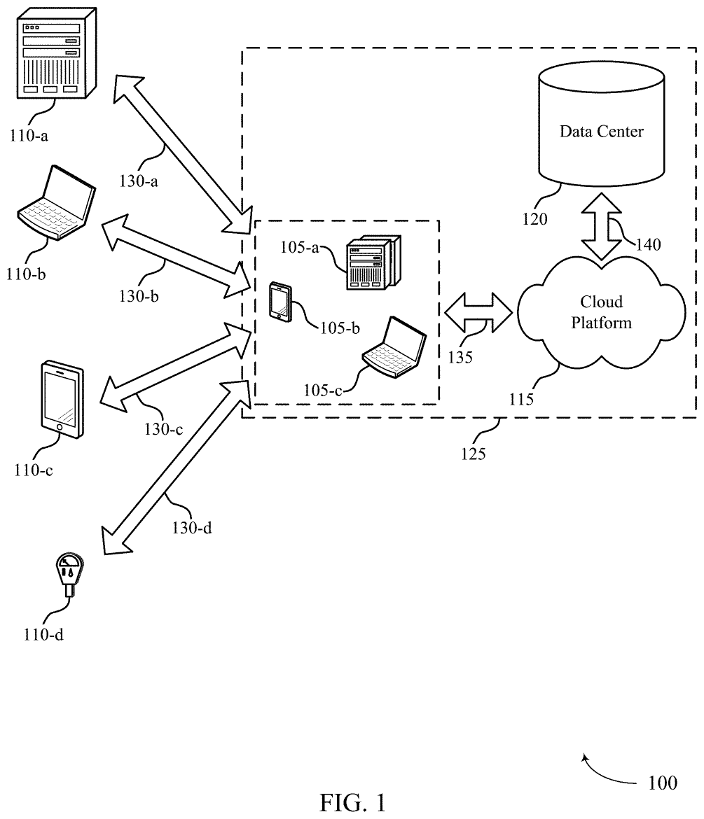

FIG. 1 illustrates an example of a system 100 for cloud computing that supports using multiple data sources for communication event action identification in accordance with various aspects of the present disclosure. The system 100 includes cloud clients 105, contacts 110, cloud platform 115, and data center 120. Cloud platform 115 may be an example of a public or private cloud network. A cloud client 105 may access cloud platform 115 over network connection 135. The network may implement transfer control protocol and internet protocol (TCP/IP), such as the Internet, or may implement other network protocols. A cloud client 105 may be an example of a user device, such as a server (e.g., cloud client 105-a), a smartphone (e.g., cloud client 105-b), or a laptop (e.g., cloud client 105-c). In other examples, a cloud client 105 may be a desktop computer, a tablet, a sensor, or another computing device or system capable of generating, analyzing, transmitting, or receiving communications. In some examples, a cloud client 105 may be operated by a user that is part of a business, an enterprise, a non-profit, a startup, or any other organization type.

A cloud client 105 may interact with multiple contacts 110. The interactions 130 may include communications, opportunities, purchases, sales, or any other interaction between a cloud client 105 and a contact 110. Data may be associated with the interactions 130. A cloud client 105 may access cloud platform 115 to store, manage, and process the data associated with the interactions 130. In some cases, the cloud client 105 may have an associated security or permission level. A cloud client 105 may have access to certain applications, data, and database information within cloud platform 115 based on the associated security or permission level, and may not have access to others.

Contacts 110 may interact with the cloud client 105 in person or via phone, email, web, text messages, mail, or any other appropriate form of interaction (e.g., interactions 130-a, 130-b, 130-c, and 130-d). The interaction 130 may be a business-to-business (B2B) interaction or a business-to-consumer (B2C) interaction. A contact 110 may also be referred to as a customer, a potential customer, a lead, a client, or some other suitable terminology. In some cases, the contact 110 may be an example of a user device, such as a server (e.g., contact 110-a), a laptop (e.g., contact 110-b), a smartphone (e.g., contact 110-c), or a sensor (e.g., contact 110-d). In other cases, the contact 110 may be another computing system. In some cases, the contact 110 may be operated by a user or group of users. The user or group of users may be associated with a business, a manufacturer, or any other appropriate organization.

Cloud platform 115 may offer an on-demand database service to the cloud client 105. In some cases, cloud platform 115 may be an example of a multi-tenant database system. In this case, cloud platform 115 may serve multiple cloud clients 105 with a single instance of software. However, other types of systems may be implemented, including—but not limited to—client-server systems, mobile device systems, and mobile network systems. In some cases, cloud platform 115 may support CRM solutions. This may include support for sales, service, marketing, community, analytics, applications, and the Internet of Things. Cloud platform 115 may receive data associated with contact interactions 130 from the cloud client 105 over network connection 135, and may store and analyze the data. In some cases, cloud platform 115 may receive data directly from an interaction 130 between a contact 110 and the cloud client 105. In some cases, the cloud client 105 may develop applications to run on cloud platform 115. Cloud platform 115 may be implemented using remote servers. In some cases, the remote servers may be located at one or more data centers 120.

Data center 120 may include multiple servers. The multiple servers may be used for data storage, management, and processing. Data center 120 may receive data from cloud platform 115 via connection 140, or directly from the cloud client 105 or an interaction 130 between a contact 110 and the cloud client 105. Data center 120 may utilize multiple redundancies for security purposes. In some cases, the data stored at data center 120 may be backed up by copies of the data at a different data center (not pictured).

Subsystem 125 may include cloud clients 105, cloud platform 115, and data center 120. In some cases, data processing may occur at any of the components of subsystem 125, or at a combination of these components. In some cases, servers may perform the data processing. The servers may be a cloud client 105 or located at data center 120.

For example, a cloud client 105 may access one or more tools for coordination of a communication event, which may be located at or supported by the cloud platform 115. For example, the clout platform may support an electronic communication application (e.g., an email application, messaging application, meeting application) that is used to communicate electronic communications and schedule meetings. Aspects of the cloud platform 115 or subsystem 125 may identify contact identifiers associated with the communication event (e.g., invitees of the communication event). The cloud platform 115 may retrieve information associated with the contact identifiers (e.g., from the data center 120 or other data sources), and the information may include electronic messages received from one or more of the contacts, contact information associated with the one or more contacts, etc. Based on this information, the cloud platform 115 may generate one or more contact characteristics (e.g., characteristics associated with the contacts, such as a job title, job level, job function, other characteristics, or any combination thereof) and may further identify one or more actions that may be performed (e.g., send a follow-up email to a contact that has not yet responded to an invitation to join the communication event).

In some approaches to communication event coordination or management, information that may be helpful to such coordination or management may be spread across various systems or locations, and may not be accessible in a unified manner. For example, such systems or data storage locations are often isolated and retrieval or collection of such information across various disparate sources is difficult. As such, information from such sources is not available to users of meeting tools, and it is difficult for users to make judgments about scheduling, rescheduling, modifying, or otherwise managing meetings.

The subject matter described herein discusses approaches to collecting and analyzing data from these various sources to provide suggestions to users for management of communication events. A cloud platform (e.g., cloud platform 115) may collect and analyze information from these sources, and the sources may contain information associated with one or more invitees, participants, contacts, or other entities associated with the communication event. Further, a cloud platform may then provide suggestions to a user based on the data collected from these various isolated data sources that may not be apparent without such collection and analysis. In this way, the data that was previously inaccessible or isolated may be leveraged and aggregated with other inaccessible or isolated data to provide further “insights” into communication events and management thereof.

For example, a user in charge of coordinating a meeting involving various people (such as a high-level executive, an attorney, engineers, and a marketing team) may send invitations to these people to join a meeting. However, responses to the meeting may vary, and some may not response at all. For example, the attorney and engineers may response affirmatively, the marketing team may decline the invitation, and the high-level executive may not reply either way. Using the approaches described herein, a cloud platform may provide the meeting coordinator with a way to analyze and collect information about each of these contacts. For example, the cloud platform may identify the role and level of each of the invitees (e.g., from emails previously sent) and the cloud platform may further identify the “RSVP” status of each of the contacts and pair that with the role and level obtained. Based on this collected information and analyzed association (e.g., between the role/level and the RSVP status), the cloud platform 115 may suggest to the meeting manager that the meeting be rescheduled since the high-level executive (who may be a person of importance to have in the meeting or a decision-maker) has not yet responded. Additionally or alternatively, the cloud platform 115 may suggest to the meeting manager that a follow-up message be sent to the high-level executive about the meeting. In this way, the meeting manager may more effectively manage the meeting, and, thanks to the clearer context and relations between the data obtained as a result of the data collection and analysis, make better decisions (in some cases, aided by the suggestions generated by the cloud platform 115).

Techniques or approaches described herein may leverage data associated with one or more contacts associated with a communication event to support identification of communication event actions. For example, such data associated with contacts of a communication event may be retrieved to generate one or more contact characteristics (e.g., job title, job level, job function, response status, other characteristics, or any combination thereof). Based on these contact characteristics, a communication event system may generate one or more suggested actions (e.g., actions associated with the communication event, such as following up on an unconfirmed meeting invitation, inviting one or more additional contacts, or other actions as described herein). As such, these techniques may enhance communication event management systems. For example, additional data, context about such data, and connections between data elements may be identified and leveraged to generate or suggest actions that may not otherwise be available or discernable to other communication event management systems (e.g. systems dealing with isolated data sources). In some examples, the information for the various data sources may be aggregated and combined in order to support action identification and enhanced communication event systems. Additionally, because the system supports improved insights regarding electronic communication events, the system may support reduced processing and memory usage by reducing or limiting wasteful electronic communications.

It should be appreciated by a person skilled in the art that one or more aspects of the disclosure may be implemented in a system 100 to additionally or alternatively solve other problems than those described above. Furthermore, aspects of the disclosure may provide technical improvements to “conventional” systems or processes as described herein. However, the description and appended drawings only include example technical improvements resulting from implementing aspects of the disclosure, and accordingly do not represent all of the technical improvements provided within the scope of the claims.

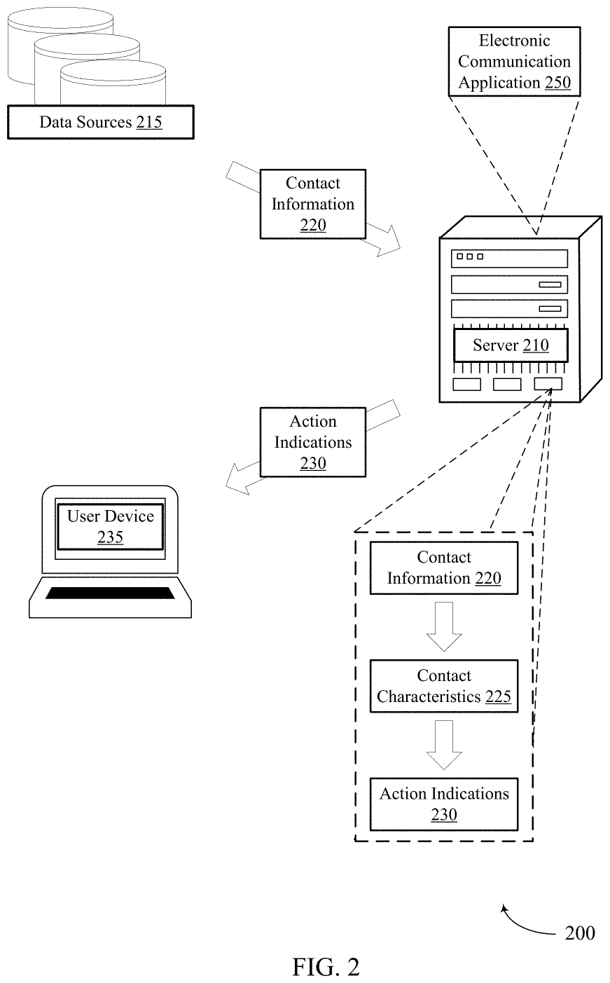

FIG. 2 illustrates an example of a data processing system 200 that supports using multiple data sources for communication event action identification in accordance with aspects of the present disclosure. The data processing system 200 may include a server 210, data sources 215, and a user device 235. Though this figure and accompanying discussion includes the server 210, it is to be understood that such approaches may be implemented in various ways, including on a cloud platform (e.g., cloud platform 115 as described herein), multiple servers, multiple computing systems, or in other ways.

In some examples, the server 210 may identify contact identifiers (e.g., email addresses, usernames, names, nicknames, physical or mailing addresses, other contact identifiers, or any combination thereof) associated with one or more contacts that may be associated with a communication event. A communication event may be or include an in-person meeting, a virtual meeting (e.g., internet video conference, voice conference, a virtual or augmented reality meeting, or other virtual meeting), a phone call, a chat room meeting, a social media page (e.g., a social media comments section), other communication events, or any combination thereof. The contacts may receive an invitation or other message associated with the communication event, may be associated with an organization including one or more members that have received an invitation, or may otherwise be associated with the communication event. In some examples, the communication event may be scheduled by an electronic communication application 250 supported by or associated with the server 210 or another computing system. The electronic communication application 250 may be an example of an email application, messaging application, meeting application, or a combination thereof. The electronic communication application 250 may be accessible via the user device 235 as a client side application associated with the electronic communication application 250.

In some examples, the server 210 may retrieve information, such as the contact information 220 from the data sources 215. The data sources 215 may be any data source that may contain or aid in locating information about the contacts (e.g., the contact information 220). For example, the data sources 215 may be an email server, storage for meeting transcripts or recordings, social media messaging storage, a web server for hosting web conferences, a web server for static or dynamic websites, video storage, audio storage, other data sources, storage associated with a customer relationship management system, a contact data store, or any combination thereof. The contact information 220 may be information associated with or information about the contacts. For example, the contact information 220 may include email messages, a biography page on a company website, a news article, information retrieved from a contact file, other information about the contacts, or any combination thereof. The contact information 220 may include information about a response of the contact to the communication event. For example, if a contact has received a meeting invitation from a calendar program, the contact information 220 may include a status indicating whether the contact has responded to the invitation, and if so, how the contact has responded (e.g., accepted, declined, suggested a new time, or other response).

In some examples, the server 210 may generate, select, determine, or otherwise obtain contact characteristics 225 for the contacts. For example, the server 210 may determine a job function or role (e.g., legal, marketing, human resources, executives), a job level (entry-level, middle management, upper management, trainer, or other job levels), a response status, other contact characteristics 225 about the contact, or any combination thereof. For example, the server 210 may collect information about whether a high-level executive has responded to a meeting invitation and may determine a response status based on such information (e.g., accepted, declined, new time suggested, etc.). Further, the contact characteristics 225 may include, indicate, analyze, or note relationships or attributes between various contact characteristics. For example, the server 210 may indicate that contacts of a job function all declined the invitation, or that contacts of one or more job levels suggested different times for the meeting. In some examples, the contact characteristics may be identified directly from the contact information (e.g., the information associated with the contact indicates a job function or level). In the same or in alternative examples, contact characteristics are derived based on the retrieved contact information. For example, the server 210 may generate the contact characteristics 225 using a machine learning model (e.g., a classification machine learning model, a clustering or prediction machine learning model, a decision-making machine learning model, one or more other machine learning models, or any combination thereof). In this way, the server 210 may present connections between the data in the data sources 215 that may not be otherwise available.

The contact characteristics 225 may be obtained directly from the contact information 220 retrieved from data sources 215. For example, a contact file or object retrieved from the sources 315 may indicate a job function/role and job level. In the same or in other cases, the characteristics 225 are derived based on the contact information 220 retrieved from the data sources 215. In one example, the server 210 may parse email signature information from prior communications stored in communication data store or in the communication event object associated with the communication event. As a result of the parsing, the server 210 may identify a string in a signature line as “executive,” “CEO,” “CFO,” “counsel,” etc. Using these identified strings, the server 210 (e.g., via machine learning or natural language processing models) may identify one or more characteristics 225, such as a job function or job level. Similar parsing and identification techniques may be used on company websites (e.g., contact pages), news articles, or other data sources 215.

In some examples, the server 210 may identify, select, determine, or otherwise obtain one or more action indications 230. The one or more action indications 230 may include one or more actions that may be suggested to a user (e.g., via the user device 235). For example, the actions may include actions associated with the communication event, such as rescheduling the event, sending one or more follow-up messages to invitations, cancelling the communication event, or other actions. Additionally or alternatively, the one or more action indications 230 may include or be associated with one or more actions or functions of a communication event management tool (e.g., rescheduling the event, sending one or more follow-up messages to invitations, cancelling the communication event, changing one or more parameters or elements of a communication event object, or other actions or functions).

In some examples, the one or more actions may be identified based on a combination of a job title/role, job level, and RSVP status that are obtained or derived from the retrieved information associated with the one or more contacts. For example, the job title/role and job level may be identified from respective predefined lists of job titles and roles. Further, some or all combinations of job functions, job levels, and RSVP statuses may be mapped to one or more actions that are identified. For example, for a job function of officer, job level of executive, and RSVP status as declined or no response, an identified action may be to transmit a follow up email to the contact. Thus, combinations of the three dimensions (e.g., job function, job level, and RSVP status) may be mapped to various actions that are identified by the server 210.

In some examples, the server 210 may transmit the one or more one or more action indications 230 to the user device 235 for presentation to the user. For example, the one or more actions may be indicated to the user device 235 via a user interface of the electronic communication application 250. The one or more action indications 230 may be presented in a user interface that may include indications of the contacts, the contact information 220, the contact characteristics 225, the one or more action indications 230, one or more statuses associated with the contacts, one or more statuses associated with the one or more action indications 230, elements for selecting one or more of the one or more action indications 230 (e.g., to select an action associated with the communication event or the one or more action indications 230 that may be implemented or performed by the server 210), other information associated with the communication event, or any combination thereof

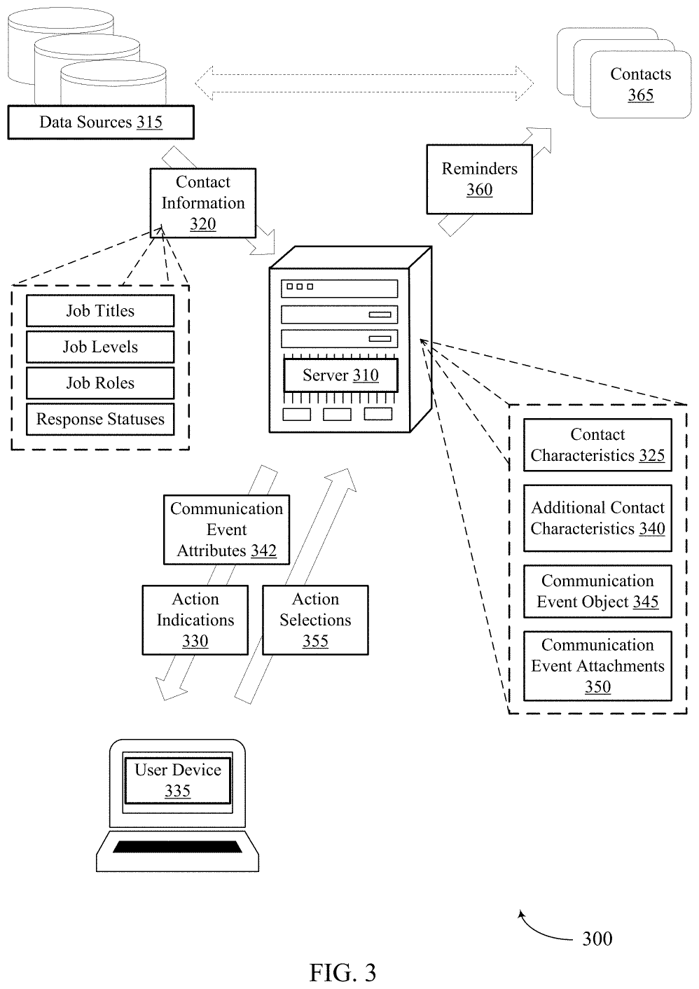

FIG. 3 illustrates an example of a data processing system 300 that supports using multiple data sources for communication event action identification in accordance with aspects of the present disclosure. The data processing system 300 may include a server 310, data sources 315, a user device 335, other devices, or any combination thereof, which may transmit, receive, process, or otherwise interact with the contact information 320, the contact characteristics 325, the action indications 330, the event attributes 342, the communication event object 345, the communication event attachments 350, the communication event attributes 342, the action selections 355, the reminders 360, the contacts 365, other elements, or any combination thereof. The server 310 may support an electronic communication application (e.g., electronic communication application 250 of FIG. 2). Though example devices, interactions, steps, processes, or elements are described herein in relation to FIG. 3, other combinations of devices, interactions, steps, processes, or elements are contemplated by the subject matter described herein.

As described herein, the server 310 may retrieve the contact information 320 from the data sources 315. In some examples, the contact information 320 may include information associated with the contacts 365. Such information could include information associated with or indicative of j ob titles, job levels, job roles, response statuses, biographies or descriptions of the contacts, email messages, chat messages, meeting recordings or transcripts, email messages, email signatures, or any combination thereof. As depicted in FIG. 3, the contacts 365 may themselves provide such information to the data sources 315, and the data sources 315 may communicate in turn with the contacts 365. For example, a data source 315 may include a website external to the server 310 that may include information about a contact 365, such as a biography on a corporate website about a contact 365 (e.g., a high-level executive). In another example, a data source 315 may be an email server (e.g., an email server associated with an organization for which the communication event manager may work) that may contain email messages that were sent by a contact 365.

As described herein, the server 310 may generate the contact characteristics 325 based on the retrieved contact information 320. However, the server 310 may also generate, retrieve, determine, select, or otherwise obtain additional contact characteristics 340. The additional contact characteristics 340 may include additional information, attributes, characteristics, behaviors, or aspects of or about the contacts 365. For example, the additional contact characteristics 340 may include information indicating that a contact has sometimes, never, or rarely responded to an email or meeting invitation, that a contact frequently arrives late to a meeting, that the contact frequently reschedules meetings for a time of day (e.g., afternoons instead of mornings), other attributes or behaviors, or any combination thereof. Such additional contact characteristics 340 may be retrieved, selected, determined, or otherwise obtained from the data sources 315, other sources of information, from logging or records created or maintained by the server 310 (e.g., information about previous communication events), other sources, or any combination thereof

In some examples, the server 310 may create, maintain, update, or otherwise manage a communication event object 345. The communication event object 345 may include information about the communication event, such as invitees, members, organizers, response information (e.g., response statuses), dates, times, communication event attachments 350, descriptions or summaries of a meeting, other information about or associated with the communication event, or any combination thereof. The communication event object 345 may be created in response to a user action (e.g., scheduling a corresponding meeting through the use of the user device 335), may be automatically created by the server 310 (e.g., based on a recurring series of communication events, one or more triggers, or other elements), or may be imported from another source.

The communication event object 345 may also store, transmit (e.g., to the user device 335), or be associated with communication event attributes 342. Such communication event attributes 342 may include or be associated with characteristics, suggestions, insights, or other information about the communication event. For example, the server 310 may generate one or more communication event attributes 342 based on one or more factors, including the contact information 320 (e.g., information associated with job titles, job levels, job roles, responses, other information, or any combination thereof), the contact characteristics 325 (e.g., the determined job titles, job levels, job roles, responses statuses, the additional contact characteristics 340, the communication event object 345, the communication event attachments 350, the action selections 355, the reminders 360, other factors, or any combination thereof. For example, the communication event attributes may indicate that a meeting should be held in a different conference room based on a number of responses from the contacts 365. For example, if few contacts 365 have responded, a smaller room may be used. Additionally or alternatively, if one or more contacts 365 of a particular job role, such as marketing, have responded, a room with a television may be suggested so that the contacts 365 associated with marketing may present marketing materials. Additionally or alternatively, depending on a response status of particular contacts 365 that may work remotely, a virtual meeting may be proposed instead of an in-person meeting.

Additionally or alternatively, the server 310 may determine, generate, select, retrieve, or otherwise obtain one or more communication event attachments 350 based on one or more factors, including the contact information 320 (e.g., information associated with job titles, job levels, job roles, responses, other information, or any combination thereof), the contact characteristics 325 (e.g., the determined job titles, job levels, job roles, responses statuses, the additional contact characteristics 340, the communication event attributes 342, the communication event object 345, the action selections 355, the reminders 360, other factors, or any combination thereof. For example, the server 310 may include one or more attachments for particular groups of attendees based on the determined job roles. Additionally or alternatively, the server 310 may include one or more attachments based on the communication event object 345, which may provide additional information or context about the communication event. For example, if a communication event contains one or more keywords, one or more documents may be automatically added as attachments to the communication event object 345 or may be automatically transmitted to one or more contacts 365 that may be attending the communication event. Various combinations or alternatives are possible and are not limited by the particular examples provided herein.

In some examples, the server 310 may transmit one or more action indications 330 to the user device 335 (e.g., via an electronic communication application) that may suggest one or more actions based on one or more factors, including the contact information 320 (e.g., information associated with job titles, job levels, job roles, responses, other information, or any combination thereof), the contact characteristics 325 (e.g., the determined job titles, job levels, job roles, responses statuses, the additional contact characteristics 340, the communication event attributes 342, the communication event object 345, the communication event attachments 350, the action selections 355, the reminders 360, other factors, or any combination thereof. For example, the server 310 may determine that one or more contacts 365 have not responded to an invitation to a virtual meeting, and may transmit the reminders 360 to the contacts 365 that have not yet responded. In another example, the server 310 may determine that one or more contacts 365 that have responded that they will attend the communication event carry a job role of legal (e.g., they are attorneys, paralegals, or other legal professionals). In such an event, the server 310 may transmit an action indications 330 that suggests one or more additional invitees, such as a lawyer from the communication event manager's organization. Similarly, the server 310 may identify that one or more contacts with an RSVP status of accepted or attending may have a function of engineer or chief technical officer. In such cases, the server 310 may transmit an action indications 330 that suggest one or more additional invites, such as an engineer or technical person from the manager's organization. In this way, the server 310 may provide automatic suggestions for actions associated with the communication event.

In some examples, the various elements of the approaches described herein may be triggered by events, conditions, or information. Such elements may include the approaches as a whole or one or more portions of the approaches (e.g., data retrieval, generation of contact characteristics 325, transmission of action indications 330, other elements, or any combination thereof). For example, the generation and transmission of action indications 330 as described herein may be triggered upon creation or modification (e.g., manually or automatically) of a communication event object 345, reception of one or more responses to communication event, crawling or analysis of newly-received information in one or more of the data sources 315, upon a request received from the user device 335, expiration of a timer (e.g., for an amount of time from creation of a communication event object 345 after which one or more reminders 360 may be sent), a designated time, one or more other factors, or any combination thereof.

In some examples, the server 310 may store or transmit the collected, generated, selected, determined, or otherwise obtained information associated with the subject matter described herein, such as the contact information 320 (e.g., information associated with job titles, job levels, job roles, responses, other information, or any combination thereof), the contact characteristics 325 (e.g., the determined job titles, job levels, job roles, responses statuses, the additional contact characteristics 340, the communication event attributes 342, the communication event object 345, the communication event attachments 350, the action selections 355, the reminders 360, other information, or any combination thereof. For example, the server 310 may maintain or access additional data storage for storage of such information so that additional insights, actions, objects, suggestions, or other elements of the subject matter described herein may be performed based on such stored information. For example, the server 310 may store one or more additional contact characteristics 340 that were generated in associated with a first communication event. Later, in connection with a second communication event, the server 310 may access the stored information to modify a communication event object 345 to include information about or associated with the additional contact characteristics 340. Various combinations are possible and are contemplated by the approaches described herein.

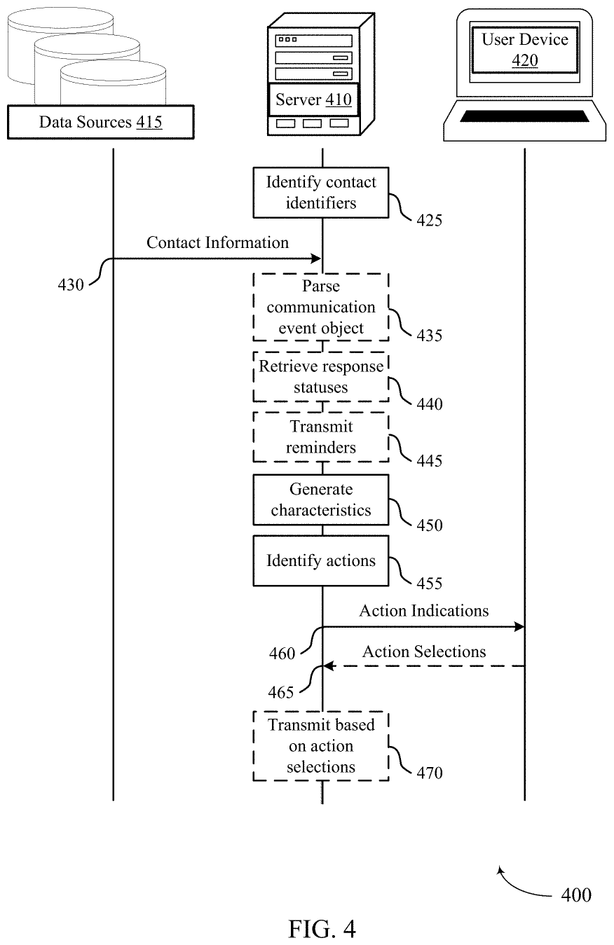

FIG. 4 illustrates an example of a process flow 400 that supports using multiple data sources for communication event action identification in accordance with aspects of the present disclosure. The process flow 400 may implement various aspects of the present disclosure described with reference to FIGS. 1-3. The process flow 400 may include a server 410 and one or more data sources 415, a user device 420, or any combination thereof, which may be examples of server 210 and server 310, data sources 215 and data sources 315, and user device 235 and user device 335 as described with reference to FIGS. 1-3.

In the following description of the process flow 400, the operations between the server 410, the data sources 415, and the user device 420 may be performed in different orders or at different times. Some operations may also be left out of the process flow 400, or other operations may be added. Although the server 410, the data sources 415, and the user device 420 are shown performing the operations of the process flow 400, one or more aspects of one or more operations may also be performed by one or more other devices.

At 425, the server 410 may identify one or more contact identifiers associated with one or more contacts that are scheduled to participate in a communication event that is scheduled through an electronic communication application.

At 430, the server 410 may retrieve information associated with the one or more contacts from one or more data sources (e.g., the data sources 415) based on the one or more contact identifiers, wherein the one or more data sources include at least electronic messages received from at least one of the one or more contacts through the electronic communication application. In some examples, the server 410 may retrieve one or more additional contact characteristics associated with one or more previous communications events associated with the one or more contacts. In some examples, the server 410 may add the one or more additional contact characteristics to the set of contact characteristics. In some examples, the server 410 may transmit, to the user device, an indication of the set of contact characteristics. In some examples, the one or more data sources may include customer relationship management data storage storing data associated with at least one of the one or more contacts, electronic message data storage storing prior electronic communications associated with the electronic communication application, communication event transcript or communication event recording data storage, or any combination thereof

At 435, the server 410 may parse a communication event object based on a creation or modification of the communication event object associated with the communication event. In some examples, the server 410 may identify, based on the parsing, one or more communication event characteristics. In some examples, the parsing may include parsing signature lines of prior communications associated with the communication event.

At 440, the server 410 may retrieve one or more response statuses associated with the one or more contacts for the communication event.

At 445, the server 410 may transmit, based on the one or more response statuses, one or more reminders associated with the communication event at one or more predefined time instances relative to the communication event.

At 450, the server 410 may generate, based on the information retrieved from the one or more data sources, a set of contact characteristics for the one or more contacts. In some examples, the server 410 may generate a job level and a job role for a first contact of the one or more contacts based on the retrieved information. In some examples, the server 410 may identify the job level from a predefined list of lob levels based on the retrieved information. In some examples, the server 410 may identify the job role from a predefined list of job roles based on the retrieved information. In some examples, the server 410 may generate the set of contact characteristics using a machine learning model. In some examples, the server 410 may select one or more communication event attachments based on the set of contact characteristics. In some examples, the server 410 may transmit, to the one or more contacts, an indication of the one or more communication event attachments.

At 455, the server 410 may identify one or more actions to be performed via the electronic communication application and associated with the communication event based on the generated set of contact characteristics and a response status associated with the communication event for a first contact of the one or more contacts. The one or more actions may be identified based on a combination of the job level, the job role, and the response status. The one or more actions may be identified based on the identified communication event characteristics. In some examples, the one or more actions may include rescheduling the communication event, transmitting a reminder associated with the communication event, transmitting an invitation associated with the communication event, scheduling one or more additional contacts to participate in the communication event, updating one or more contacts that are scheduled to participate in the communication event, or any combination thereof.

At 460, the server 410 may transmit, to the user device 420, an indication of the identified one or more actions. At 465, the server 410 may receive, from a user interface associated with the electronic communication application (e.g., presented at the user device 420), an indication of selection of an action of the one or more actions. At 470, the server 410 may transmit, via the electronic communication application, an electronic communication corresponding to the action that is selected via the user interface.

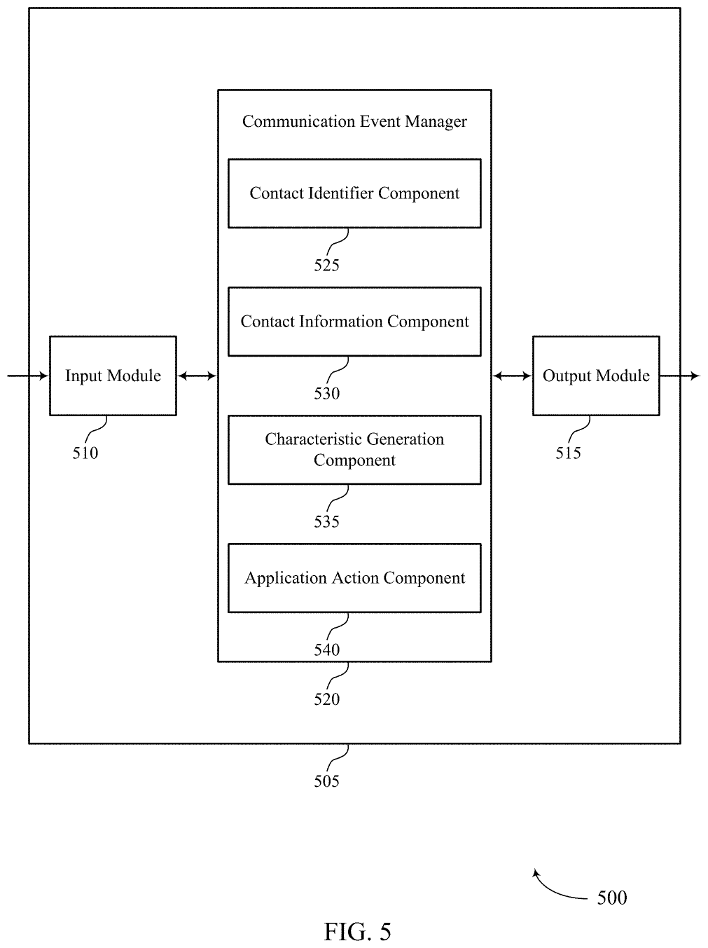

FIG. 5 shows a block diagram 500 of a device 505 that supports using multiple data sources for communication event action identification in accordance with aspects of the present disclosure. The device 505 may include an input module 510, an output module 515, and a communication event manager 520. The device 505 may also include a processor. Each of these components may be in communication with one another (e.g., via one or more buses).

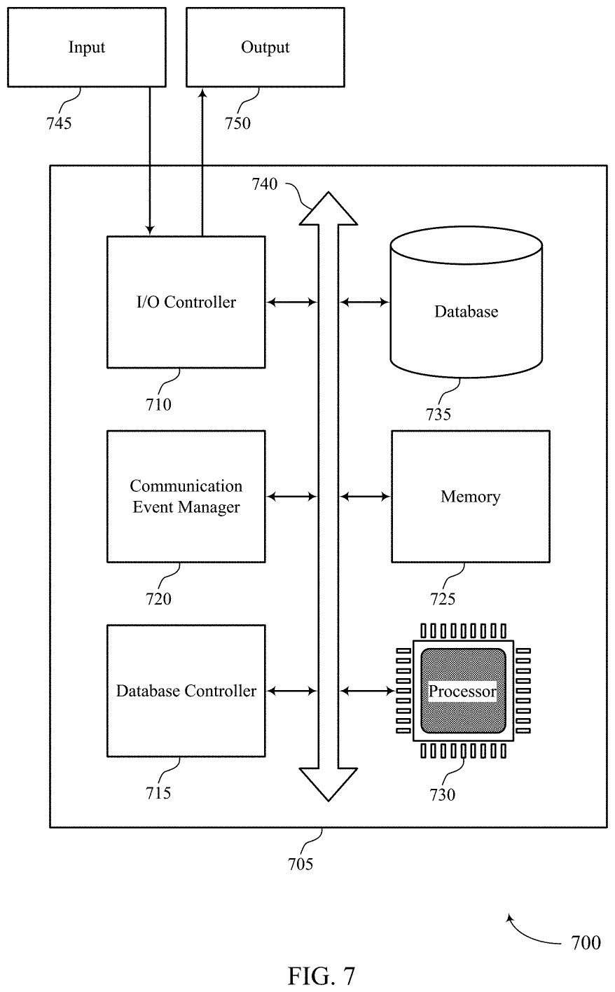

The input module 510 may manage input signals for the device 505. For example, the input module 510 may identify input signals based on an interaction with a modem, a keyboard, a mouse, a touchscreen, or a similar device. These input signals may be associated with user input or processing at other components or devices. In some cases, the input module 510 may utilize an operating system such as iOS®, ANDROID®, MS-DOS®, MS-WINDOWS®, OS/2®, UNIX®, LINUX®, or another known operating system to handle input signals. The input module 510 may send aspects of these input signals to other components of the device 505 for processing. For example, the input module 510 may transmit input signals to the communication event manager 520 to support using multiple data sources for communication event action identification . In some cases, the input module 510 may be a component of an I/O controller 710 as described with reference to FIG. 7.

The output module 515 may manage output signals for the device 505. For example, the output module 515 may receive signals from other components of the device 505, such as the communication event manager 520, and may transmit these signals to other components or devices. In some examples, the output module 515 may transmit output signals for display in a user interface, for storage in a database or data store, for further processing at a server or server cluster, or for any other processes at any number of devices or systems. In some cases, the output module 515 may be a component of an I/O controller 710 as described with reference to FIG. 7.

For example, the communication event manager 520 may include a contact identifier component 525, a contact information component 530, a characteristic generation component 535, an application action component 540, or any combination thereof. In some examples, the communication event manager 520, or various components thereof, may be configured to perform various operations (e.g., receiving, monitoring, transmitting) using or otherwise in cooperation with the input module 510, the output module 515, or both. For example, the communication event manager 520 may receive information from the input module 510, send information to the output module 515, or be integrated in combination with the input module 510, the output module 515, or both to receive information, transmit information, or perform various other operations as described herein.

The communication event manager 520 may support data processing at an application server in accordance with examples as disclosed herein. The contact identifier component 525 may be configured as or otherwise support a means for identifying one or more contact identifiers associated with one or more contacts that are scheduled to participate in a communication event that is scheduled through an electronic communication application. The contact information component 530 may be configured as or otherwise support a means for retrieving information associated with the one or more contacts from one or more data sources based at least in part on the one or more contact identifiers, wherein the one or more data sources include at least electronic messages received from at least one of the one or more contacts through the electronic communication application. The characteristic generation component 535 may be configured as or otherwise support a means for generating, based at least in part on the information retrieved from the one or more data sources, a set of contact characteristics for the one or more contacts. The application action component 540 may be configured as or otherwise support a means for identifying one or more actions to be performed via the electronic communication application and associated with the communication event based at least in part on the generated set of contact characteristics and a response status associated with the communication event for a first contact of the one or more contacts. The application action component 540 may be configured as or otherwise support a means for transmitting, to a user device, an indication of the identified one or more actions.

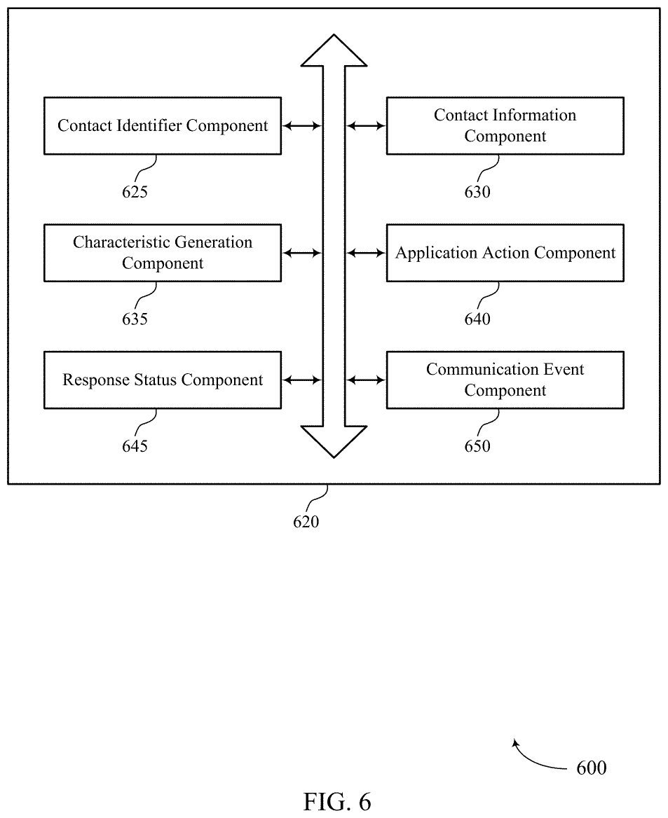

FIG. 6 shows a block diagram 600 of a communication event manager 620 that supports using multiple data sources for communication event action identification in accordance with aspects of the present disclosure. The communication event manager 620 may be an example of aspects of a communication event manager or a communication event manager 520, or both, as described herein. The communication event manager 620, or various components thereof, may be an example of means for performing various aspects of using multiple data sources for communication event action identification as described herein. For example, the communication event manager 620 may include a contact identifier component 625, a contact information component 630, a characteristic generation component 635, an application action component 640, a response status component 645, a communication event component 650, or any combination thereof. Each of these components may communicate, directly or indirectly, with one another (e.g., via one or more buses).

The communication event manager 620 may support data processing at an application server in accordance with examples as disclosed herein. The contact identifier component 625 may be configured as or otherwise support a means for identifying one or more contact identifiers associated with one or more contacts that are scheduled to participate in a communication event that is scheduled through an electronic communication application. The contact information component 630 may be configured as or otherwise support a means for retrieving information associated with the one or more contacts from one or more data sources based at least in part on the one or more contact identifiers, wherein the one or more data sources include at least electronic messages received from at least one of the one or more contacts through the electronic communication application. The characteristic generation component 635 may be configured as or otherwise support a means for generating, based at least in part on the information retrieved from the one or more data sources, a set of contact characteristics for the one or more contacts. The application action component 640 may be configured as or otherwise support a means for identifying one or more actions to be performed via the electronic communication application and associated with the communication event based at least in part on the generated set of contact characteristics and a response status associated with the communication event for a first contact of the one or more contacts. In some examples, the application action component 640 may be configured as or otherwise support a means for transmitting, to a user device, an indication of the identified one or more actions.

In some examples, to support generating the set of contact characteristics, the characteristic generation component 635 may be configured as or otherwise support a means for generating a job level and a job role for the first contact of the one or more contacts based at least in part on the retrieved information, wherein the one or more actions are identified based at least in part on the job level, the job role, and the response status.

In some examples, the characteristic generation component 635 may be configured as or otherwise support a means for identifying the job level from a predefined list of lob levels based at least in part on the retrieved information. In some examples, the characteristic generation component 635 may be configured as or otherwise support a means for identifying the job role from a predefined list of j ob roles based at least in part on the retrieved information.

In some examples, the application action component 640 may be configured as or otherwise support a means for receiving, from a user interface associated with the electronic communication application, an indication of selection of an action of the one or more actions. In some examples, the application action component 640 may be configured as or otherwise support a means for transmitting, via the electronic communication application, an electronic communication corresponding to the action that is selected via the user interface.

In some examples, the response status component 645 may be configured as or otherwise support a means for retrieving one or more response statuses associated with the one or more contacts for the communication event, wherein generating the set of contact characteristics is based at least in part on the one or more response statuses.

In some examples, the response status component 645 may be configured as or otherwise support a means for transmitting, based at least in part on the one or more response statuses, one or more reminders associated with the communication event at one or more predefined time instances relative to the communication event.

In some examples, the communication event component 650 may be configured as or otherwise support a means for parsing a communication event object based at least in part on a creation or modification of the communication event object associated with the communication event. In some examples, the communication event component 650 may be configured as or otherwise support a means for identifying, based at least in part on the parsing, one or more communication event characteristics, wherein the one or more actions are identified based at least in part on the one or more communication event characteristics.

In some examples, the characteristic generation component 635 may be configured as or otherwise support a means for retrieving one or more additional contact characteristics associated with one or more previous communications events associated with the one or more contacts. In some examples, the characteristic generation component 635 may be configured as or otherwise support a means for adding the one or more additional contact characteristics to the set of contact characteristics. In some examples, the characteristic generation component 635 may be configured as or otherwise support a means for transmitting, to the user device, an indication of the set of contact characteristics.

In some examples, the characteristic generation component 635 may be configured as or otherwise support a means for generating the set of contact characteristics using a machine learning model.

In some examples, the characteristic generation component 635 may be configured as or otherwise support a means for selecting one or more communication event attachments based at least in part on the set of contact characteristics. In some examples, the characteristic generation component 635 may be configured as or otherwise support a means for transmitting, to the one or more contacts, an indication of the one or more communication event attachments.

In some examples, the one or more actions comprise rescheduling the communication event, transmitting a reminder associated with the communication event, transmitting an invitation associated with the communication event, scheduling one or more additional contacts to participate in the communication event, updating one or more contacts that are scheduled to participate in the communication event, or any combination thereof.

In some examples, the one or more data sources comprise customer relationship management data storage storing data associated with at least one of the one or more contacts, electronic message data storage storing prior electronic communications associated with the electronic communication application, communication event transcript or communication event recording data storage, or any combination thereof

FIG. 7 shows a diagram of a system 700 including a device 705 that supports using multiple data sources for communication event action identification in accordance with aspects of the present disclosure. The device 705 may be an example of or include the components of a device 505 as described herein. The device 705 may include components for bi-directional data communications including components for transmitting and receiving communications, such as a communication event manager 720, an I/O controller 710, a database controller 715, a memory 725, a processor 730, and a database 735. These components may be in electronic communication or otherwise coupled (e.g., operatively, communicatively, functionally, electronically, electrically) via one or more buses (e.g., a bus 740).

The I/O controller 710 may manage input signals 745 and output signals 750 for the device 705. The I/O controller 710 may also manage peripherals not integrated into the device 705. In some cases, the I/O controller 710 may represent a physical connection or port to an external peripheral. In some cases, the I/O controller 710 may utilize an operating system such as iOS®, ANDROID®, MS-DOS®, MS-WINDOWS®, OS/2®, UNIX®, LINUX®, or another known operating system. In other cases, the I/O controller 710 may represent or interact with a modem, a keyboard, a mouse, a touchscreen, or a similar device. In some cases, the I/O controller 710 may be implemented as part of a processor 730. In some examples, a user may interact with the device 705 via the I/O controller 710 or via hardware components controlled by the I/O controller 710.

The database controller 715 may manage data storage and processing in a database 735. In some cases, a user may interact with the database controller 715. In other cases, the database controller 715 may operate automatically without user interaction. The database 735 may be an example of a single database, a distributed database, multiple distributed databases, a data store, a data lake, or an emergency backup database.

Memory 725 may include random-access memory (RAM) and ROM. The memory 725 may store computer-readable, computer-executable software including instructions that, when executed, cause the processor 730 to perform various functions described herein. In some cases, the memory 725 may contain, among other things, a BIOS which may control basic hardware or software operation such as the interaction with peripheral components or devices.

The processor 730 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 730 may be configured to operate a memory array using a memory controller. In other cases, a memory controller may be integrated into the processor 730. The processor 730 may be configured to execute computer-readable instructions stored in a memory 725 to perform various functions (e.g., functions or tasks supporting using multiple data sources for communication event action identification).

The communication event manager 720 may support data processing at an application server in accordance with examples as disclosed herein. For example, the communication event manager 720 may be configured as or otherwise support a means for identifying one or more contact identifiers associated with one or more contacts that are scheduled to participate in a communication event that is scheduled through an electronic communication application. The communication event manager 720 may be configured as or otherwise support a means for retrieving information associated with the one or more contacts from one or more data sources based at least in part on the one or more contact identifiers, wherein the one or more data sources include at least electronic messages received from at least one of the one or more contacts through the electronic communication application. The communication event manager 720 may be configured as or otherwise support a means for generating, based at least in part on the information retrieved from the one or more data sources, a set of contact characteristics for the one or more contacts. The communication event manager 720 may be configured as or otherwise support a means for identifying one or more actions to be performed via the electronic communication application and associated with the communication event based at least in part on the generated set of contact characteristics and a response status associated with the communication event for a first contact of the one or more contacts. The communication event manager 720 may be configured as or otherwise support a means for transmitting, to a user device, an indication of the identified one or more actions.

By including or configuring the communication event manager 720 in accordance with examples as described herein, the device 705 may support techniques for improved communication reliability, reduced latency, improved user experience related to reduced processing, reduced power consumption, more efficient utilization of communication resources, improved coordination between devices, longer battery life, improved utilization of processing capability, or a combination thereof

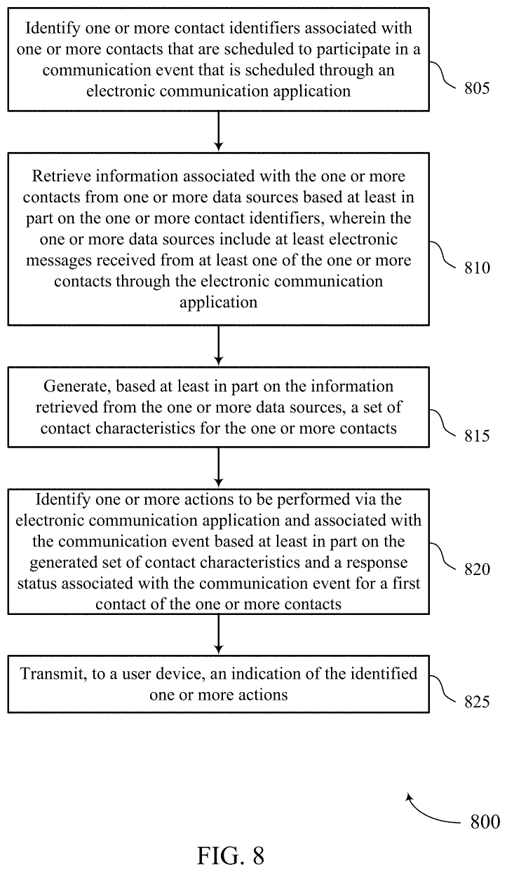

FIG. 8 shows a flowchart illustrating a method 800 that supports using multiple data sources for communication event action identification in accordance with aspects of the present disclosure. The operations of the method 800 may be implemented by an Application Server or its components as described herein. For example, the operations of the method 800 may be performed by an Application Server as described with reference to FIGs. FIG. 1 through 7. In some examples, an Application Server may execute a set of instructions to control the functional elements of the Application Server to perform the described functions. Additionally or alternatively, the Application Server may perform aspects of the described functions using special-purpose hardware.

At 805, the method may include identifying one or more contact identifiers associated with one or more contacts that are scheduled to participate in a communication event that is scheduled through an electronic communication application. The operations of 805 may be performed in accordance with examples as disclosed herein. In some examples, aspects of the operations of 805 may be performed by a contact identifier component 625 as described with reference to FIG. 6.

At 810, the method may include retrieving information associated with the one or more contacts from one or more data sources based at least in part on the one or more contact identifiers, wherein the one or more data sources include at least electronic messages received from at least one of the one or more contacts through the electronic communication application. The operations of 810 may be performed in accordance with examples as disclosed herein. In some examples, aspects of the operations of 810 may be performed by a contact information component 630 as described with reference to FIG. 6.

At 815, the method may include generating, based at least in part on the information retrieved from the one or more data sources, a set of contact characteristics for the one or more contacts. The operations of 815 may be performed in accordance with examples as disclosed herein. In some examples, aspects of the operations of 815 may be performed by a characteristic generation component 635 as described with reference to FIG. 6.

At 820, the method may include identifying one or more actions to be performed via the electronic communication application and associated with the communication event based at least in part on the generated set of contact characteristics and a response status associated with the communication event for a first contact of the one or more contacts. The operations of 820 may be performed in accordance with examples as disclosed herein. In some examples, aspects of the operations of 820 may be performed by an application action component 640 as described with reference to FIG. 6.

At 825, the method may include transmitting, to a user device, an indication of the identified one or more actions. The operations of 825 may be performed in accordance with examples as disclosed herein. In some examples, aspects of the operations of 825 may be performed by an application action component 640 as described with reference to FIG. 6.

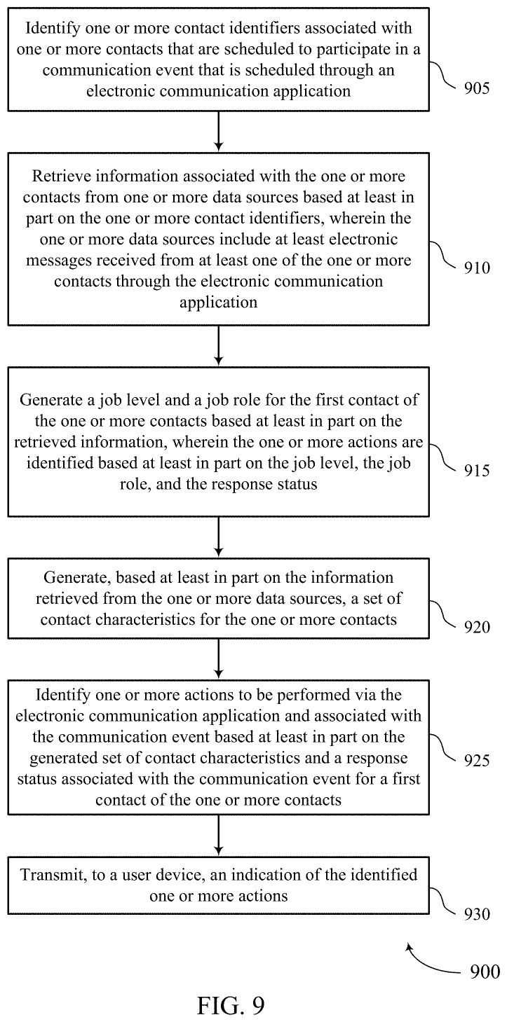

FIG. 9 shows a flowchart illustrating a method 900 that supports using multiple data sources for communication event action identification in accordance with aspects of the present disclosure. The operations of the method 900 may be implemented by an Application Server or its components as described herein. For example, the operations of the method 900 may be performed by an Application Server as described with reference to FIGs. FIG. 1 through 7. In some examples, an Application Server may execute a set of instructions to control the functional elements of the Application Server to perform the described functions. Additionally or alternatively, the Application Server may perform aspects of the described functions using special-purpose hardware.

At 905, the method may include identifying one or more contact identifiers associated with one or more contacts that are scheduled to participate in a communication event that is scheduled through an electronic communication application. The operations of 905 may be performed in accordance with examples as disclosed herein. In some examples, aspects of the operations of 905 may be performed by a contact identifier component 625 as described with reference to FIG. 6.

At 910, the method may include retrieving information associated with the one or more contacts from one or more data sources based at least in part on the one or more contact identifiers, wherein the one or more data sources include at least electronic messages received from at least one of the one or more contacts through the electronic communication application. The operations of 910 may be performed in accordance with examples as disclosed herein. In some examples, aspects of the operations of 910 may be performed by a contact information component 630 as described with reference to FIG. 6.

At 915, the method may include generating a job level and a job role for the first contact of the one or more contacts based at least in part on the retrieved information, wherein the one or more actions are identified based at least in part on the job level, the job role, and the response status. The operations of 915 may be performed in accordance with examples as disclosed herein. In some examples, aspects of the operations of 915 may be performed by a characteristic generation component 635 as described with reference to FIG. 6.

At 920, the method may include generating, based at least in part on the information retrieved from the one or more data sources, a set of contact characteristics for the one or more contacts. The operations of 920 may be performed in accordance with examples as disclosed herein. In some examples, aspects of the operations of 920 may be performed by a characteristic generation component 635 as described with reference to FIG. 6.

At 925, the method may include identifying one or more actions to be performed via the electronic communication application and associated with the communication event based at least in part on the generated set of contact characteristics and a response status associated with the communication event for a first contact of the one or more contacts. The operations of 925 may be performed in accordance with examples as disclosed herein. In some examples, aspects of the operations of 925 may be performed by an application action component 640 as described with reference to FIG. 6.

At 930, the method may include transmitting, to a user device, an indication of the identified one or more actions. The operations of 930 may be performed in accordance with examples as disclosed herein. In some examples, aspects of the operations of 930 may be performed by an application action component 640 as described with reference to FIG. 6.

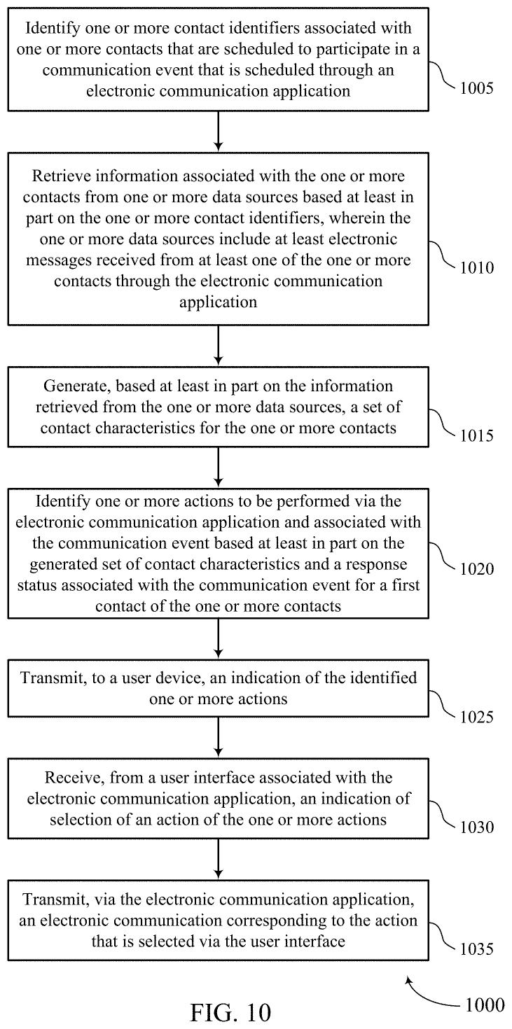

FIG. 10 shows a flowchart illustrating a method 1000 that supports using multiple data sources for communication event action identification in accordance with aspects of the present disclosure. The operations of the method 1000 may be implemented by an Application Server or its components as described herein. For example, the operations of the method 1000 may be performed by an Application Server as described with reference to FIGs. FIG. 1 through 7. In some examples, an Application Server may execute a set of instructions to control the functional elements of the Application Server to perform the described functions. Additionally or alternatively, the Application Server may perform aspects of the described functions using special-purpose hardware.

At 1005, the method may include identifying one or more contact identifiers associated with one or more contacts that are scheduled to participate in a communication event that is scheduled through an electronic communication application. The operations of 1005 may be performed in accordance with examples as disclosed herein. In some examples, aspects of the operations of 1005 may be performed by a contact identifier component 625 as described with reference to FIG. 6.

At 1010, the method may include retrieving information associated with the one or more contacts from one or more data sources based at least in part on the one or more contact identifiers, wherein the one or more data sources include at least electronic messages received from at least one of the one or more contacts through the electronic communication application. The operations of 1010 may be performed in accordance with examples as disclosed herein. In some examples, aspects of the operations of 1010 may be performed by a contact information component 630 as described with reference to FIG. 6.

At 1015, the method may include generating, based at least in part on the information retrieved from the one or more data sources, a set of contact characteristics for the one or more contacts. The operations of 1015 may be performed in accordance with examples as disclosed herein. In some examples, aspects of the operations of 1015 may be performed by a characteristic generation component 635 as described with reference to FIG. 6.

At 1020, the method may include identifying one or more actions to be performed via the electronic communication application and associated with the communication event based at least in part on the generated set of contact characteristics and a response status associated with the communication event for a first contact of the one or more contacts. The operations of 1020 may be performed in accordance with examples as disclosed herein. In some examples, aspects of the operations of 1020 may be performed by an application action component 640 as described with reference to FIG. 6.

At 1025, the method may include transmitting, to a user device, an indication of the identified one or more actions. The operations of 1025 may be performed in accordance with examples as disclosed herein. In some examples, aspects of the operations of 1025 may be performed by an application action component 640 as described with reference to FIG. 6.

At 1030, the method may include receiving, from a user interface associated with the electronic communication application, an indication of selection of an action of the one or more actions. The operations of 1030 may be performed in accordance with examples as disclosed herein. In some examples, aspects of the operations of 1030 may be performed by an application action component 640 as described with reference to FIG. 6.

At 1035, the method may include transmitting, via the electronic communication application, an electronic communication corresponding to the action that is selected via the user interface. The operations of 1035 may be performed in accordance with examples as disclosed herein. In some examples, aspects of the operations of 1035 may be performed by an application action component 640 as described with reference to FIG. 6.

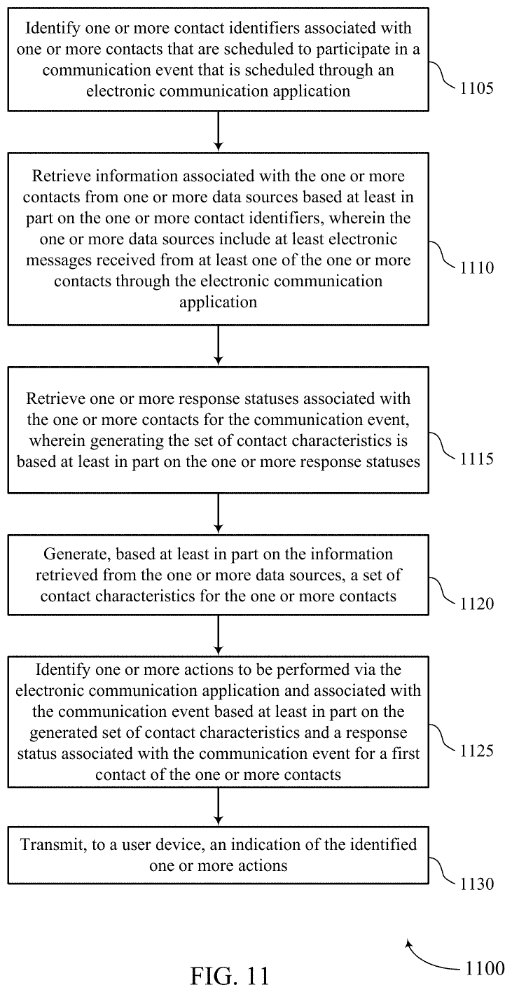

FIG. 11 shows a flowchart illustrating a method 1100 that supports using multiple data sources for communication event action identification in accordance with aspects of the present disclosure. The operations of the method 1100 may be implemented by an Application Server or its components as described herein. For example, the operations of the method 1100 may be performed by an Application Server as described with reference to FIGs. FIG. 1 through 7. In some examples, an Application Server may execute a set of instructions to control the functional elements of the Application Server to perform the described functions. Additionally or alternatively, the Application Server may perform aspects of the described functions using special-purpose hardware.

At 1105, the method may include identifying one or more contact identifiers associated with one or more contacts that are scheduled to participate in a communication event that is scheduled through an electronic communication application. The operations of 1105 may be performed in accordance with examples as disclosed herein. In some examples, aspects of the operations of 1105 may be performed by a contact identifier component 625 as described with reference to FIG. 6.

At 1110, the method may include retrieving information associated with the one or more contacts from one or more data sources based at least in part on the one or more contact identifiers, wherein the one or more data sources include at least electronic messages received from at least one of the one or more contacts through the electronic communication application. The operations of 1110 may be performed in accordance with examples as disclosed herein. In some examples, aspects of the operations of 1110 may be performed by a contact information component 630 as described with reference to FIG. 6.

At 1115, the method may include retrieving one or more response statuses associated with the one or more contacts for the communication event, wherein generating the set of contact characteristics is based at least in part on the one or more response statuses. The operations of 1115 may be performed in accordance with examples as disclosed herein. In some examples, aspects of the operations of 1115 may be performed by a response status component 645 as described with reference to FIG. 6.

At 1120, the method may include generating, based at least in part on the information retrieved from the one or more data sources, a set of contact characteristics for the one or more contacts. The operations of 1120 may be performed in accordance with examples as disclosed herein. In some examples, aspects of the operations of 1120 may be performed by a characteristic generation component 635 as described with reference to FIG. 6.

At 1125, the method may include identifying one or more actions to be performed via the electronic communication application and associated with the communication event based at least in part on the generated set of contact characteristics and a response status associated with the communication event for a first contact of the one or more contacts. The operations of 1125 may be performed in accordance with examples as disclosed herein. In some examples, aspects of the operations of 1125 may be performed by an application action component 640 as described with reference to FIG. 6.

At 1130, the method may include transmitting, to a user device, an indication of the identified one or more actions. The operations of 1130 may be performed in accordance with examples as disclosed herein. In some examples, aspects of the operations of 1130 may be performed by an application action component 640 as described with reference to FIG. 6.

A method for data processing at an application server is described. The method may include identifying one or more contact identifiers associated with one or more contacts that are scheduled to participate in a communication event that is scheduled through an electronic communication application, retrieving information associated with the one or more contacts from one or more data sources based at least in part on the one or more contact identifiers, wherein the one or more data sources include at least electronic messages received from at least one of the one or more contacts through the electronic communication application, generating, based at least in part on the information retrieved from the one or more data sources, a set of contact characteristics for the one or more contacts, identifying one or more actions to be performed via the electronic communication application and associated with the communication event based at least in part on the generated set of contact characteristics and a response status associated with the communication event for a first contact of the one or more contacts, and transmitting, to a user device, an indication of the identified one or more actions.

An apparatus for data processing at an application server is described. The apparatus may include a processor, memory coupled with the processor, and instructions stored in the memory. The instructions may be executable by the processor to cause the apparatus to identify one or more contact identifiers associated with one or more contacts that are scheduled to participate in a communication event that is scheduled through an electronic communication application, retrieve information associated with the one or more contacts from one or more data sources based at least in part on the one or more contact identifiers, wherein the one or more data sources include at least electronic messages received from at least one of the one or more contacts through the electronic communication application, generate, based at least in part on the information retrieved from the one or more data sources, a set of contact characteristics for the one or more contacts, identify one or more actions to be performed via the electronic communication application and associated with the communication event based at least in part on the generated set of contact characteristics and a response status associated with the communication event for a first contact of the one or more contacts, and transmit, to a user device, an indication of the identified one or more actions.

Another apparatus for data processing at an application server is described. The apparatus may include means for identifying one or more contact identifiers associated with one or more contacts that are scheduled to participate in a communication event that is scheduled through an electronic communication application, means for retrieving information associated with the one or more contacts from one or more data sources based at least in part on the one or more contact identifiers, wherein the one or more data sources include at least electronic messages received from at least one of the one or more contacts through the electronic communication application, means for generating, based at least in part on the information retrieved from the one or more data sources, a set of contact characteristics for the one or more contacts, means for identifying one or more actions to be performed via the electronic communication application and associated with the communication event based at least in part on the generated set of contact characteristics and a response status associated with the communication event for a first contact of the one or more contacts, and means for transmitting, to a user device, an indication of the identified one or more actions.

A non-transitory computer-readable medium storing code for data processing at an application server is described. The code may include instructions executable by a processor to identify one or more contact identifiers associated with one or more contacts that are scheduled to participate in a communication event that is scheduled through an electronic communication application, retrieve information associated with the one or more contacts from one or more data sources based at least in part on the one or more contact identifiers, wherein the one or more data sources include at least electronic messages received from at least one of the one or more contacts through the electronic communication application, generate, based at least in part on the information retrieved from the one or more data sources, a set of contact characteristics for the one or more contacts, identify one or more actions to be performed via the electronic communication application and associated with the communication event based at least in part on the generated set of contact characteristics and a response status associated with the communication event for a first contact of the one or more contacts, and transmit, to a user device, an indication of the identified one or more actions.

In some examples of the method, apparatuses, and non-transitory computer-readable medium described herein, generating the set of contact characteristics may include operations, features, means, or instructions for generating a job level and a job role for the first contact of the one or more contacts based at least in part on the retrieved information, wherein the one or more actions may be identified based at least in part on the job level, the job role, and the response status.

Some examples of the method, apparatuses, and non-transitory computer-readable medium described herein may further include operations, features, means, or instructions for identifying the job level from a predefined list of lob levels based at least in part on the retrieved information and identifying the job role from a predefined list of job roles based at least in part on the retrieved information.

Some examples of the method, apparatuses, and non-transitory computer-readable medium described herein may further include operations, features, means, or instructions for receiving, from a user interface associated with the electronic communication application, an indication of selection of an action of the one or more actions and transmitting, via the electronic communication application, an electronic communication corresponding to the action that may be selected via the user interface.

Some examples of the method, apparatuses, and non-transitory computer-readable medium described herein may further include operations, features, means, or instructions for retrieving one or more response statuses associated with the one or more contacts for the communication event, wherein generating the set of contact characteristics may be based at least in part on the one or more response statuses.

Some examples of the method, apparatuses, and non-transitory computer-readable medium described herein may further include operations, features, means, or instructions for transmitting, based at least in part on the one or more response statuses, one or more reminders associated with the communication event at one or more predefined time instances relative to the communication event.

Some examples of the method, apparatuses, and non-transitory computer-readable medium described herein may further include operations, features, means, or instructions for parsing a communication event object based at least in part on a creation or modification of the communication event object associated with the communication event and identifying, based at least in part on the parsing, one or more communication event characteristics, wherein the one or more actions may be identified based at least in part on the one or more communication event characteristics.

Some examples of the method, apparatuses, and non-transitory computer-readable medium described herein may further include operations, features, means, or instructions for retrieving one or more additional contact characteristics associated with one or more previous communications events associated with the one or more contacts, adding the one or more additional contact characteristics to the set of contact characteristics, and transmitting, to the user device, an indication of the set of contact characteristics.

Some examples of the method, apparatuses, and non-transitory computer-readable medium described herein may further include operations, features, means, or instructions for generating the set of contact characteristics using a machine learning model.

Some examples of the method, apparatuses, and non-transitory computer-readable medium described herein may further include operations, features, means, or instructions for selecting one or more communication event attachments based at least in part on the set of contact characteristics and transmitting, to the one or more contacts, an indication of the one or more communication event attachments.

In some examples of the method, apparatuses, and non-transitory computer-readable medium described herein, the one or more actions comprise rescheduling the communication event, transmitting a reminder associated with the communication event, transmitting an invitation associated with the communication event, scheduling one or more additional contacts to participate in the communication event, updating one or more contacts that may be scheduled to participate in the communication event, or any combination thereof.

In some examples of the method, apparatuses, and non-transitory computer-readable medium described herein, the one or more data sources comprise customer relationship management data storage storing data associated with at least one of the one or more contacts, electronic message data storage storing prior electronic communications associated with the electronic communication application, communication event transcript or communication event recording data storage, or any combination thereof

It should be noted that the methods described above describe possible implementations, and that the operations and the steps may be rearranged or otherwise modified and that other implementations are possible. Furthermore, aspects from two or more of the methods may be combined.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable ROM (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for data processing at an application server, comprising:
identifying one or more contact identifiers associated with one or more contacts that are scheduled to participate in a communication event that is scheduled through an electronic communication application;
retrieving information associated with the one or more contacts from one or more data sources based at least in part on the one or more contact identifiers, wherein the one or more data sources include at least electronic messages received from at least one of the one or more contacts through the electronic communication application;
generating, based at least in part on the information retrieved from the one or more data sources, a set of contact characteristics for the one or more contacts;
identifying one or more actions to be performed via the electronic communication application and associated with the communication event based at least in part on the generated set of contact characteristics and a response status associated with the communication event for a first contact of the one or more contacts; and
transmitting, to a user device, an indication of the identified one or more actions.

2. The method of claim 1, wherein generating the set of contact characteristics comprises:
generating a job level and a job role for the first contact of the one or more contacts based at least in part on the retrieved information, wherein the one or more actions are identified based at least in part on the job level, the job role, and the response status.

3. The method of claim 2, further comprising:
identifying the job level from a predefined list of lob levels based at least in part on the retrieved information; and
identifying the job role from a predefined list of job roles based at least in part on the retrieved information.

4. The method of claim 1, further comprising:
receiving, from a user interface associated with the electronic communication application, an indication of selection of an action of the one or more actions; and
transmitting, via the electronic communication application, an electronic communication corresponding to the action that is selected via the user interface.

5. The method of claim 1, further comprising:
retrieving one or more response statuses associated with the one or more contacts for the communication event, wherein generating the set of contact characteristics is based at least in part on the one or more response statuses.

6. The method of claim 5, further comprising:
transmitting, based at least in part on the one or more response statuses, one or more reminders associated with the communication event at one or more predefined time instances relative to the communication event.

7. The method of claim 1, further comprising:
parsing a communication event object based at least in part on a creation or modification of the communication event object associated with the communication event; and
identifying, based at least in part on the parsing, one or more communication event characteristics, wherein the one or more actions are identified based at least in part on the one or more communication event characteristics.

8. The method of claim 1, further comprising:
retrieving one or more additional contact characteristics associated with one or more previous communications events associated with the one or more contacts;
adding the one or more additional contact characteristics to the set of contact characteristics; and
transmitting, to the user device, an indication of the set of contact characteristics.

9. The method of claim 1, further comprising:
generating the set of contact characteristics using a machine learning model.

10. The method of claim 1, further comprising:
selecting one or more communication event attachments based at least in part on the set of contact characteristics; and
transmitting, to the one or more contacts, an indication of the one or more communication event attachments.

11. The method of claim 1, wherein the one or more actions comprise rescheduling the communication event, transmitting a reminder associated with the communication event, transmitting an invitation associated with the communication event, scheduling one or more additional contacts to participate in the communication event, updating one or more contacts that are scheduled to participate in the communication event, or any combination thereof.

12. The method of claim 1, wherein the one or more data sources comprise customer relationship management data storage storing data associated with at least one of the one or more contacts, electronic message data storage storing prior electronic communications associated with the electronic communication application, communication event transcript or communication event recording data storage, or any combination thereof

13. An apparatus for data processing at an application server, comprising:
a processor;
memory coupled with the processor; and
instructions stored in the memory and executable by the processor to cause the apparatus to:
identify one or more contact identifiers associated with one or more contacts that are scheduled to participate in a communication event that is scheduled through an electronic communication application;
retrieve information associated with the one or more contacts from one or more data sources based at least in part on the one or more contact identifiers, wherein the one or more data sources include at least electronic messages received from at least one of the one or more contacts through the electronic communication application;
generate, based at least in part on the information retrieved from the one or more data sources, a set of contact characteristics for the one or more contacts;
identify one or more actions to be performed via the electronic communication application and associated with the communication event based at least in part on the generated set of contact characteristics and a response status associated with the communication event for a first contact of the one or more contacts; and
transmit, to a user device, an indication of the identified one or more actions.

14. The apparatus of claim 13, wherein the instructions to generate the set of contact characteristics are executable by the processor to cause the apparatus to:
generate a job level and job role for the first contact of the one or more contacts based at least in part on the retrieved information, wherein the one or more actions are identified based at least in part on the job level, the job role, and the response status.

15. The apparatus of claim 13, wherein the instructions are further executable by the processor to cause the apparatus to:
receive, from a user interface associated with the electronic communication application, an indication of selection of an action of the one or more actions; and
transmit, via the electronic communication application, an electronic communication corresponding to the action that is selected via the user interface.

16. The apparatus of claim 13, wherein the instructions are further executable by the processor to cause the apparatus to:
retrieve one or more response statuses associated with the one or more contacts for the communication event, wherein generating the set of contact characteristics is based at least in part on the one or more response statuses.

17. The apparatus of claim 13, wherein the instructions are further executable by the processor to cause the apparatus to:
parse a communication event object based at least in part on a creation or modification of the communication event object associated with the communication event; and
identify, based at least in part on the parsing, one or more communication event characteristics, wherein the one or more actions are identified based at least in part on the one or more communication event characteristics.

18. The apparatus of claim 13, wherein the instructions are further executable by the processor to cause the apparatus to:
retrieve one or more additional contact characteristics associated with one or more previous communications events associated with the one or more contacts;
add the one or more additional contact characteristics to the set of contact characteristics; and
transmit, to the user device, an indication of the set of contact characteristics.

19. A non-transitory computer-readable medium storing code for data processing at an application server, the code comprising instructions executable by a processor to:
identify one or more contact identifiers associated with one or more contacts that are scheduled to participate in a communication event that is scheduled through an electronic communication application;
retrieve information associated with the one or more contacts from one or more data sources based at least in part on the one or more contact identifiers, wherein the one or more data sources include at least electronic messages received from at least one of the one or more contacts through the electronic communication application;
generate, based at least in part on the information retrieved from the one or more data sources, a set of contact characteristics for the one or more contacts;
identify one or more actions to be performed via the electronic communication application and associated with the communication event based at least in part on the generated set of contact characteristics and a response status associated with the communication event for a first contact of the one or more contacts; and
transmit, to a user device, an indication of the identified one or more actions.

20. The non-transitory computer-readable medium of claim 19, wherein the instructions are further executable by the processor to:
retrieve one or more response statuses associated with the one or more contacts for the communication event, wherein generating the set of contact characteristics is based at least in part on the one or more response statuses.
